(19) United States
(12) Patent Application Publication
(10) Pub. No.: US 2007/0068351 A1
(43) Pub. Date: Mar. 29, 2007

(54) Depaneling system having fixture pallets positioned in an over-under configuration

(76) Inventor: Kurt John Hill, Berthoud, CO (US)

Correspondence Address: DUFT BORNSEN & FISHMAN, LLP, 1526 SPRUCE STREET, SUITE 302, BOULDER, CO, 80302, US

(21) Appl. No.: 11/273,968

(22) Filed: Nov. 15, 2005

Related U.S. Application Data
(60) Provisional application No. 60/720,766, filed on Sep. 26, 2005.

(51) Int. Cl. B26D 7/02

(52) U.S. Cl. 83/100; 83/451; 269/21; 29/743

(57) ABSTRACT

Depaneling systems are disclosed for liberating circuit boards from panels. A depaneling system of the invention includes a first fixture pallet adapted to support a first panel of circuit boards for cutting and a second fixture pallet adapted to support a second panel of circuit boards for cutting. The first fixture pallet is positioned above the second fixture pallet in the depaneling system relative to the ground to provide an over-under configuration of the fixture pallets.

### RELATED APPLICATIONS

This non-provisional application claims priority to U.S. provisional application 60/720,766, filed on Sep. 26, 2005, which is incorporated herein by reference.

### BACKGROUND OF THE INVENTION

1. Field of the Invention

The invention is related to the field of depaneling systems, and in particular, to a depaneling system having a first fixture pallet positioned above a second fixture pallet relative to the ground to provide an over-under configuration of the fixture pallets.

2. Statement of the Problem

Printed Circuit Boards (PCB) are used in many common electronic devices, such as computers and televisions. The demand for electronic devices has driven the need to mass produce the PCBs used in the electronic devices. One way to mass produce PCBs is to fabricate multiple PCBs on a panel. After being fabricated, the individual PCBs are liberated from the panel by cutting the PCBs out of the panel. The PCBs may be pre-routed so that only the remaining tabs connecting the PCBs to the panel need to be cut.

There are a variety of automated depaneling systems used to cut PCBs out of a panel. Some examples of depaneling systems are illustrated in U.S. Pat. No. 6,357,108, U.S. Pat. No. 5,894,648, U.S. Pat. No. 5,438,740, U.S. Pat. No. 5,117,554, U.S. Pat. No. 4,683,789, and U.S. Pat. No. 4,742,615, which are all incorporated herein by reference to the same extent as if fully set forth herein. A typical depaneling system has a horizontal fixture pallet and a cutting apparatus, such as a router or saw. One or both of the horizontal fixture pallet and cutting apparatus are movable with respect to one another in order to cut different PCB patterns out of the panel. To mount a panel to be cut on the horizontal fixture pallet, the horizontal fixture pallet is moved to a load/unload station of the depaneling system. An operator then registers the panel in a tooling fixture and attaches the tooling fixture to the horizontal fixture pallet. Alternatively, the operator registers the panel directly to the horizontal fixture pallet. The horizontal fixture pallet is moved from the load/unload station to a cutting station proximate to the cutting apparatus, and the cutting apparatus cuts the PCBs from the panel. The horizontal fixture pallet is then moved from the cutting station back to the load/unload station. The operator removes the PCBs and scraps of panel from the horizontal fixture pallet and registers a new panel for cutting.

To increase the throughput of the depaneling systems, some depaneling systems have side-by-side dual fixture pallets. A first panel is registered on a first fixture pallet in the load/unload station. The first fixture pallet is moved to the cutting station and the first panel is routed. While the first panel is being routed, a second panel may be registered on the second fixture pallet in the load/unload station. When cutting is completed on the first panel, the second fixture pallet is moved to the cutting station and is routed. The side-by-side configuration allows multiple panels to be handled simultaneously to increase throughput.

Although the side-by-side configuration may be desired in some applications, the footprint of the depaneling system may be larger than desired for other applications. It may be desirable for a depaneling system to have a smaller footprint while still maintaining the throughput of a side-by-side depaneling system.

### SUMMARY OF THE SOLUTION

The invention helps solve the above and other problems with a depaneling system that has at least two fixture pallets, where a first fixture pallet is positioned above the second fixture pallet in the depaneling system relative to the ground to provide an over-under configuration of the fixture pallets. The over-under configuration of the fixture pallets allows for a similar throughput as a side-by-side configuration, but advantageously allows for a depaneling system with a smaller footprint.

In an exemplary embodiment of the invention, a depaneling system includes a first fixture pallet adapted to support a first panel of circuit boards for cutting and a second fixture pallet adapted to support a second panel of circuit boards for cutting. The first fixture pallet is positioned above the second fixture pallet in the depaneling system along a vertical axis.

According to features and aspects of the invention, the depaneling system includes first rails and second rails. The first rails are positioned above the second rails relative to the ground. The first fixture pallet is moveably coupled to the first rails, and the second fixture pallet is moveably coupled to the second rails. The positioning of the rails helps determine the over-under configuration of the first fixture pallet and the second fixture pallet.

According to features and aspects of the invention, the first fixture pallet and the second fixture pallet are each movable along a horizontal axis between a load/unload station and a cutting station of the depaneling system. The depaneling system includes first drive mechanism adapted to move the first fixture pallet along the horizontal axis between the load/unload station and the cutting station. The depaneling system also includes a second drive mechanism adapted to move the second fixture pallet along the horizontal axis between the load/unload station and the cutting station.

According to features and aspects of the invention, the depaneling system further comprises a control system adapted to control movement of the first fixture pallet and the second fixture pallet between the load/unload station and the cutting station of the depaneling system. For instance, the control system is adapted to control the first drive mechanism to move the first fixture pallet to the load/unload station and to control the second drive mechanism to move the second fixture pallet to the cutting station. The control system is further adapted to control a cutting apparatus to cut the second panel registered on the second fixture pallet. The control system is further adapted to control the first drive mechanism to move the first fixture pallet from the load/unload station to the cutting station after completion of the cutting of the second panel. The control system is further adapted to control the cutting apparatus to cut the first panel registered on the second fixture pallet. The control system is further adapted to control the second drive mechanism to move the second fixture pallet from the cutting station to the load/unload station.

According to features and aspects of the invention, the first fixture pallet is adapted to tilt toward an operator when the first fixture pallet is in the load/unload station, and the second fixture pallet is adapted to tilt toward the operator when the second fixture pallet is in the load/unload station.

The invention may include other exemplary embodiments described below.

### DESCRIPTION OF THE DRAWINGS

The same reference number represents the same element on all drawings.

FIG. 1 is an isometric view of a depaneling system in an exemplary embodiment of the invention.

FIG. 2 is an isometric view of the depaneling system with the canopy removed in an exemplary embodiment of the invention.

FIG. 3 is a front view of the depaneling system in an exemplary embodiment of the invention.

FIG. 4 is another front view of the depaneling system in an exemplary embodiment of the invention.

FIG. 5 is an isometric view of the depaneling system in another exemplary embodiment of the invention.

FIG. 6 is a front view of the depaneling system in an exemplary embodiment of the invention.

FIG. 7 is an isometric view of a fixture pallet in an exemplary embodiment of the invention.

FIG. 8 is a side view of the fixture pallet with a registration member tilted toward the operator in an exemplary embodiment of the invention.

FIG. 9 is an isometric view of the fixture pallet with the registration member in a horizontal position in an exemplary embodiment of the invention.

FIG. 10 is a side view of the fixture pallet with the registration member in the horizontal position in an exemplary embodiment of the invention.

### DETAILED DESCRIPTION OF THE INVENTION

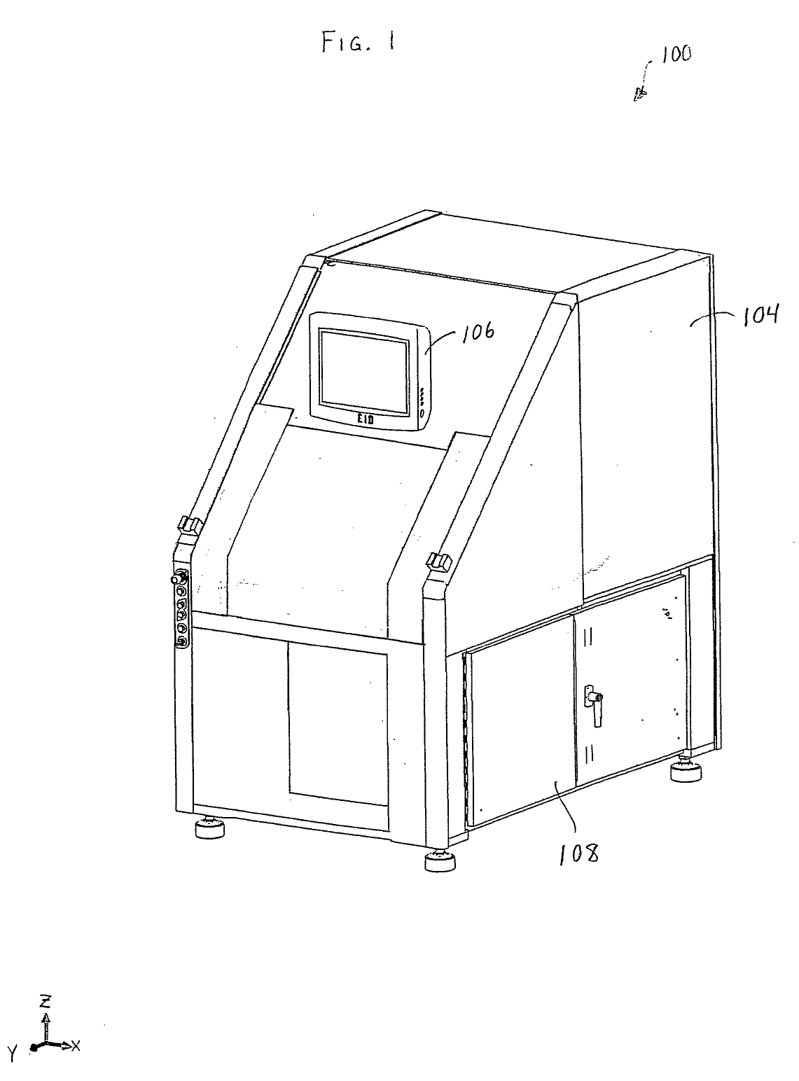

FIGS. 1-10 and the following description depict specific embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 is an isometric view of a depaneling system 100 in an exemplary embodiment of the invention. Depaneling system 100 comprises any system or device configured to cut or otherwise liberate circuit boards (referred to herein as PCBs) from panels. The panels include an array of PCBs to be cut from the panels. The PCBs may or may not be populated with components, such as processors, resisters, capacitors, etc.

Depaneling system 100 includes a control system 106 that controls the operation of depaneling system 100. Control system 106 may be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accordance with the invention. The term “processor” refers to a single processing device or a group of inter-operational processing devices. Some examples of processors are computers, integrated circuits, and logic circuitry. Those skilled in the art are familiar with instructions, processors, and storage media. The storage media and processor(s) of control system 106 may be stored behind access doors 108.

Other internal components of depaneling system 100 are covered by canopy 104 in FIG. 1.

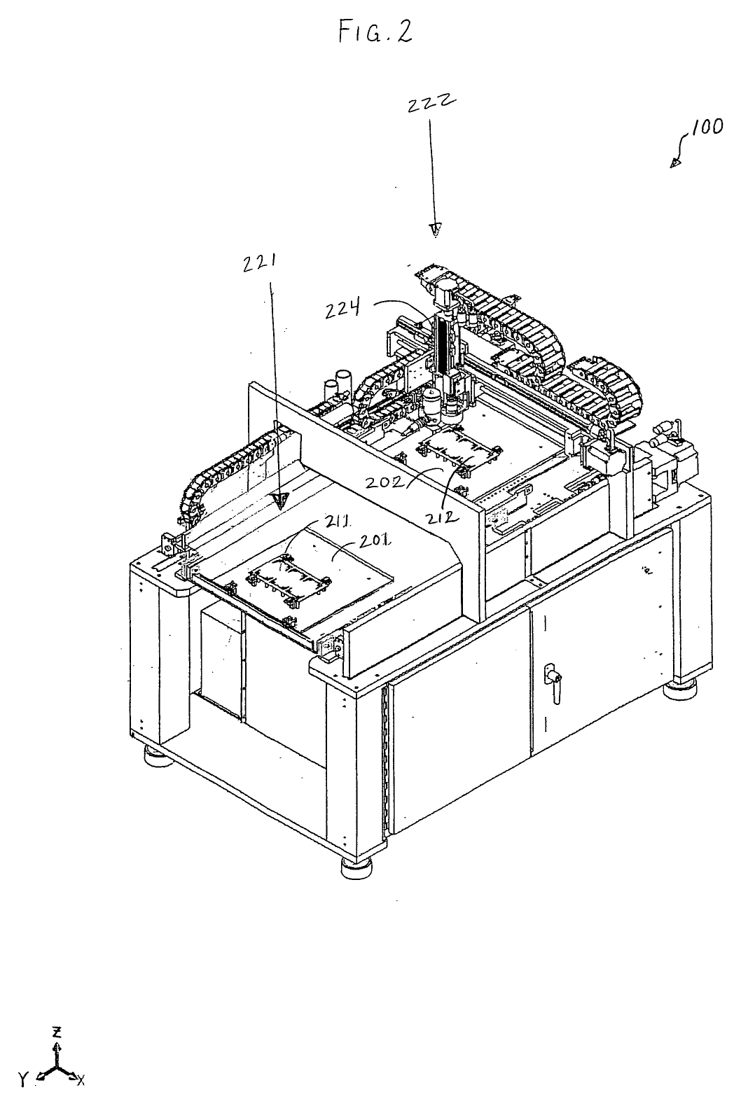

FIG. 2 is an isometric view of depaneling system 100 with the canopy 104 removed in an exemplary embodiment of the invention. Depaneling system 100 includes two fixture pallets 201-202. A fixture pallet comprises any support structure for supporting, holding, or otherwise securing a panel for cutting. A fixture pallet may include one or more clamps, one or more registration pins, or any other securing mechanism for securing a panel. Although two fixture pallets 201-202 are shown in FIG. 2, depaneling system 100 may include more than two fixture pallets in other embodiments.

Fixture pallet 201 is illustrated as securing a registered panel 211. Fixture pallet 202 is illustrated as securing a registered panel 212. Those skilled in the art understand that fixture pallets 201-202 may secure more than one panel in other embodiments.

Depaneling system 100 includes a load/unload station 221 and a cutting station 222. A load/unload station comprises the location of depaneling system 100 where panels are loaded onto a fixture pallet or unloaded from a fixture pallet by an operator or automated system. “Loading” a panel refers to registering a panel on a tooling fixture that is registered on a fixture pallet, or registering a panel directly on the fixture pallet. “Unloading” a panel refers to removing the liberated PCBs and scraps of the panel from the tooling fixture or the fixture pallet. The terms “load” and “register” may be used interchangeably herein. A cutting station comprises the location of depaneling system 100 where panels are cut by a cutting apparatus 224, such as a router, saw, laser, etc.

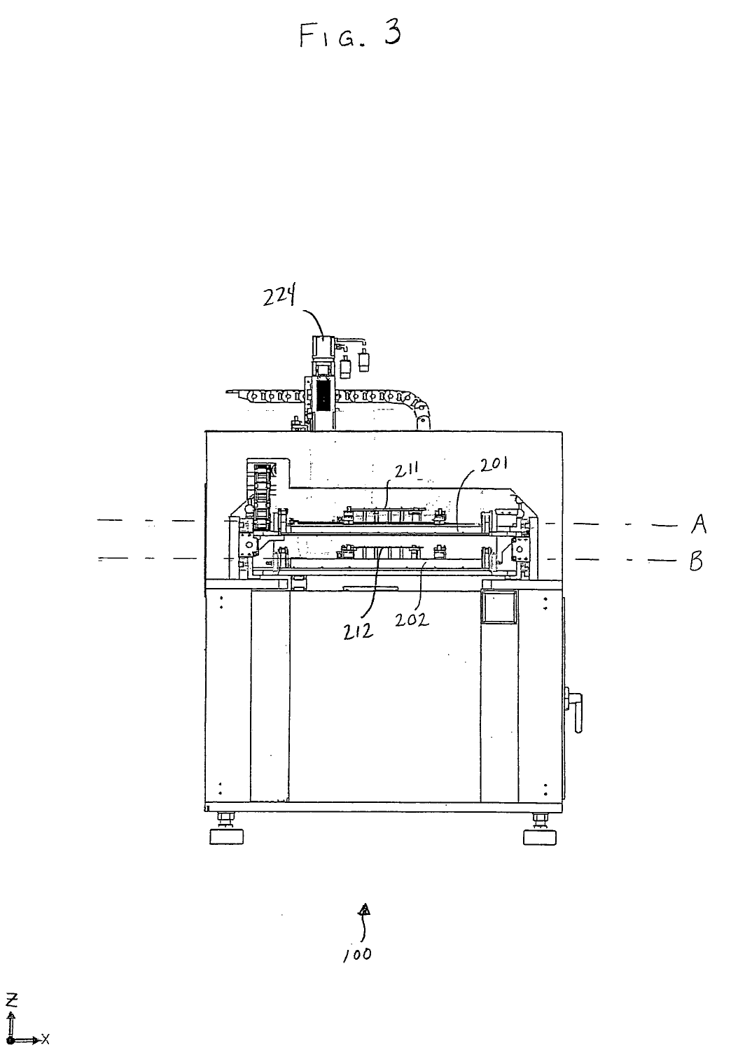

FIG. 3 is a front view of depaneling system 100 in an exemplary embodiment of the invention. For depaneling system 100, fixture pallet 201 is positioned above fixture pallet 202 along a vertical axis (which is the Z-axis in FIG. 3) relative to the ground. The positioning of fixture pallet 201 above fixture pallet 202 gives depaneling system an over-under configuration of the fixture pallets 201-202, as compared to a side-by-side configuration of other depaneling systems. Fixture pallet 201 may be positioned directly above fixture pallet 202 along the vertical axis. Alternatively, fixture pallet 201 may be horizontally offset slightly with respect to the vertical axis from fixture pallet 202 depending on the desired footprint of depaneling system 100.

Fixture pallet 201 has a major surface, which is the top surface in FIG. 3, upon which panels are registered. The major surface of fixture pallet 201 defines a first plane A. Likewise, fixture pallet 202 has a major surface, which is the top surface in FIG. 3, upon which panels are registered. The major surface of fixture pallet 202 defines a second plane B. According to the positioning of fixture pallet 201 relative to fixture pallet 202, the first plane A of fixture pallet 201 is situated above the second plane B of fixture pallet 202 along the vertical axis. The first plane A and the second plane B are substantially parallel in FIG. 3. The first plane A and the second plane B are separated along the vertical axis by a desired spacing.

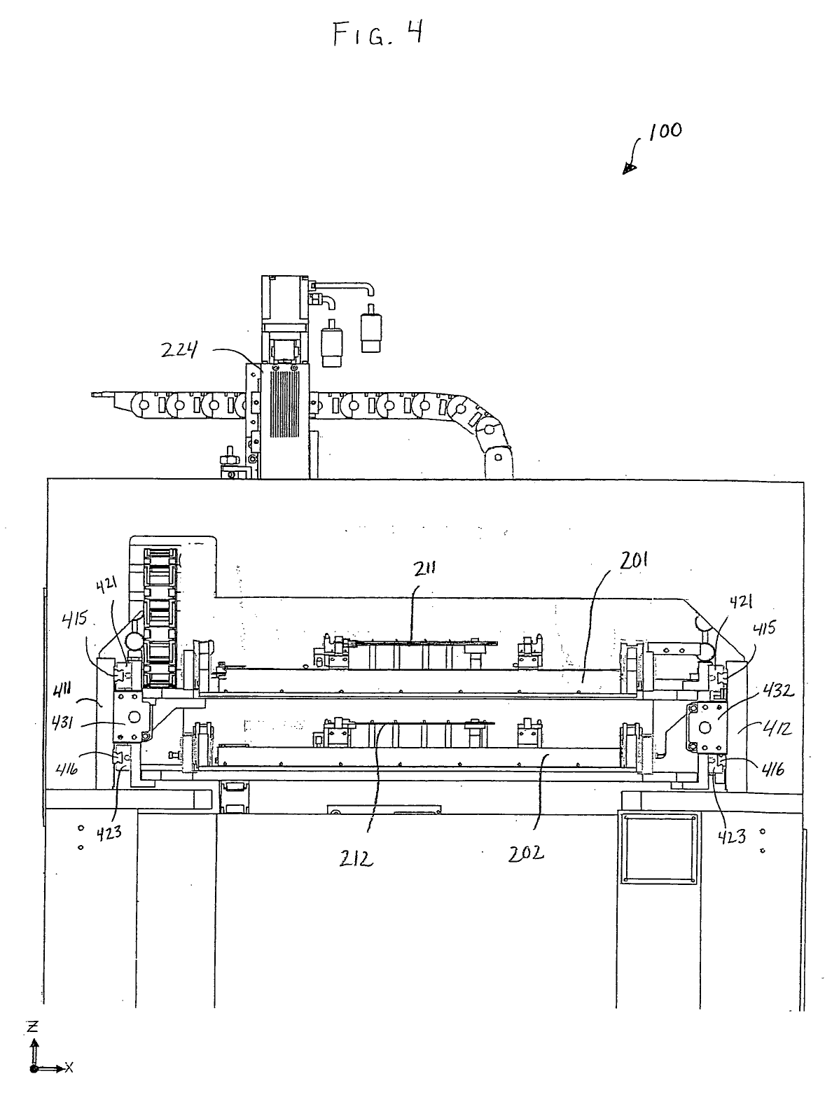

FIG. 4 is another front view of depaneling system 100 in an exemplary embodiment of the invention. The closer view in FIG. 4 shows the structure and assembly of depaneling system 100 in this embodiment, but the invention is not limited to this structure. Other depaneling systems may have other desired structures to provide the over-under configuration of the fixture pallets.

In this embodiment, depaneling system 100 includes a frame having two vertical members 411-412 on the left and right sides of FIG. 4. Vertical members 411-412 extend along the Y-axis (which is perpendicular to the page of FIG. 4) between the load/unload station 221 and the cutting station 222 (see FIG. 2). First rails 415 connect to vertical members 411-412 and extend along the Y-axis between the load/unload station 221 and the cutting station 222 (see FIG. 2). Second rails 416 also connect to vertical members 411-412 and extend along the Y-axis between the load/unload station 221 and the cutting station 222 (see FIG. 2). Rails comprise a structural member configured to allow another mating member to slide, roll, or otherwise move along the structure member.

The connection point of rails 415 to vertical members 411-412 is above the connection point of rails 416 to vertical members 411-412. The connection points of rails 415 and rails 416 help define the over-under configuration of the fixture pallets 201-202.

Fixture pallet 201 includes connection mechanisms 421 that are adapted to movably couple to rails 415. Connection mechanisms 421 comprise any members adapted to moveably couple to rails 415. The connection mechanisms 421 are moveable along rails 415 to allow movement by fixture pallet 201 along the Y-axis (which is perpendicular to the page of FIG. 4). As an example, connection mechanisms 421 may interface with rails 415 so as to slide along rails 415. Alternatively, connection mechanisms 421 may include bearings, wheels, etc, that roll along rail 415. Depaneling system 100 further includes a drive mechanism 431 adapted to move fixture pallet 201 along the Y-axis between the load/unload station 221 and the cutting station 222. An example of a drive mechanism 431 is a motor and lead screw.

Likewise, fixture pallet 202 includes connection mechanisms 423 that are adapted to movably couple to rails 416. Connection mechanisms 423 comprise any members adapted to moveably couple to rails 416. The connection mechanisms 423 are moveable along rails 416 to allow movement by fixture pallet 202 along the Y-axis (which is perpendicular to the page of FIG. 4). Depaneling system 100 further includes a drive mechanism 432 adapted to move fixture pallet 202 along the Y-axis between the load/unload station 221 and the cutting station 222.

Control system 106 (see FIG. 1) is configured to control drive mechanism 431 and drive mechanism 432 to position fixture pallet 201 and fixture pallet 202 in the desired locations in depaneling system 100. Fixture pallets 201-202 are moveable along the Y-axis independently of one another. As an example, fixture pallet 201 is illustrated in the load/unload station 221 of depaneling system 100 in FIG. 2. Fixture pallet 202 is illustrated in the cutting station 222 of depaneling system 100 in FIG. 2. Control system 106 alternates fixture pallets 201-202 between the load/unload station 221 and the cutting station 222 to allow for the cutting of a panel on one fixture pallet concurrently as a new panel is being loaded onto the other fixture pallet. An exemplary operation of depaneling system 100 is described as follows.

Assume that panel 212 has been loaded on fixture pallet 202 when fixture pallet 202 was positioned in the load/unload station 221. Control system 106 then controls drive mechanism 432 to move fixture pallet 202 from the load/unload station 221 along the Y-axis to the cutting station 222. When fixture pallet 202 is positioned in cutting station 222, control system 106 controls cutting apparatus 224 to cut the PCBs from the panel 212 registered on fixture pallet 202. Assuming that fixture pallet 201 is not already in the load/unload station 221, control system 106 controls drive mechanism 431 to move fixture pallet 201 to the load/unload station 221 along the Y-axis. When fixture pallet 201 is positioned in the load/unload station 221, an operator registers panel 211 on fixture pallet 201.

When cutting of panel 212 on fixture pallet 202 has completed, control system 106 controls drive mechanism 432 to move fixture pallet 202 from the cutting station 222 along the Y-axis to the load/unload station 221. Control system 106 also controls drive mechanism 431 to move fixture pallet 201 from the load/unload station 221 along the Y-axis to the cutting station 222. When fixture pallet 201 is positioned in cutting station 222, control system 106 controls cutting apparatus 224 to cut the PCBs from the panel 211 registered on fixture pallet 201. When fixture pallet 202 is positioned in the load/unload station 221, an operator unloads the liberated PCBs from fixture pallet 202 and removes the scraps left over from panel 212. The operator then registers another panel on fixture pallet 202, and the above process repeats.

The over-under configuration of depaneling system 100 advantageously allows depaneling system 100 to have a smaller footprint than prior depaneling systems having fixture pallets in a side-by-side configuration. At the same time, the over-under configuration of the fixture pallets 201-202 advantageously allows for a similar throughput as the side-by-side depaneling systems.

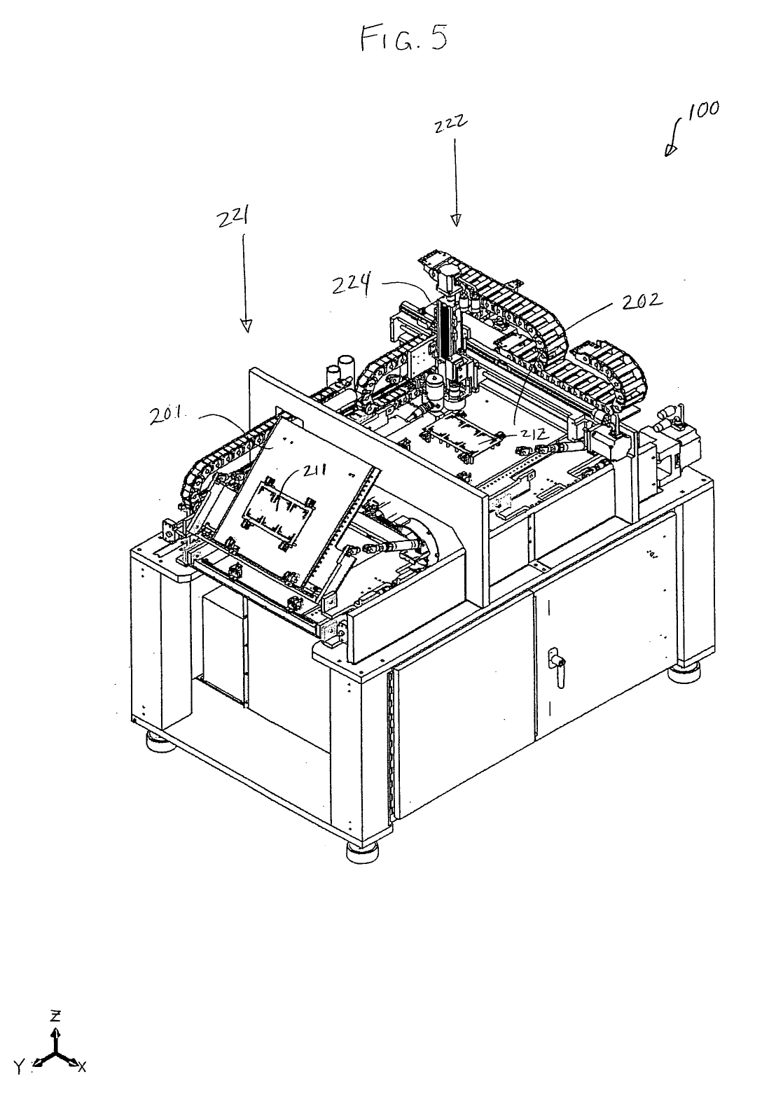

FIGS. 5-9 illustrate another embodiment of the depaneling system 100.

FIG. 5 is an isometric view of depaneling system 100 in another exemplary embodiment. In this embodiment, fixture pallet 201 and/or fixture pallet 202 are adapted to tilt toward the operator (not shown) of depaneling system 100 to allow the operator to register a panel on the fixture pallets (fixture pallet 201 is illustrated as tilted in FIG. 5). An operator of depaneling system 100 would typically stand in front of the load/unload station 221 to load panels onto fixture pallets 201-202. When in the load/unload station 221, fixture pallet 201 tilts toward the operator to allow the operator to register panel 211 on the fixture pallet 201. The position of the fixture pallet 201 as tilted toward the operator more easily and comfortably allows the operator to register panel 211 on fixture pallet 201. Those skilled in the art understand that automated systems may feed panels to a depaneling system, which is also within the scope of the invention.

Fixture pallet 202 may likewise be adapted to tilt toward the operator. Fixture pallet 202 is illustrated as being positioned in the cutting station 222 in FIG. 5. If fixture pallet 202 were moved to the load/unload station 221, then fixture pallet 202 may be able to tilt toward the operator as is illustrated for fixture pallet 201.

When panel 211 is loaded onto fixture pallet 201 and fixture pallet 201 is ready to move to cutting station 222, fixture pallet 201 may then be moved from the tilted position to a horizontal position. Fixture pallet 201 may then be moved to the cutting station 222 (which is occupied by fixture pallet 202 in FIG. 5) to provide for cutting of panel 211.

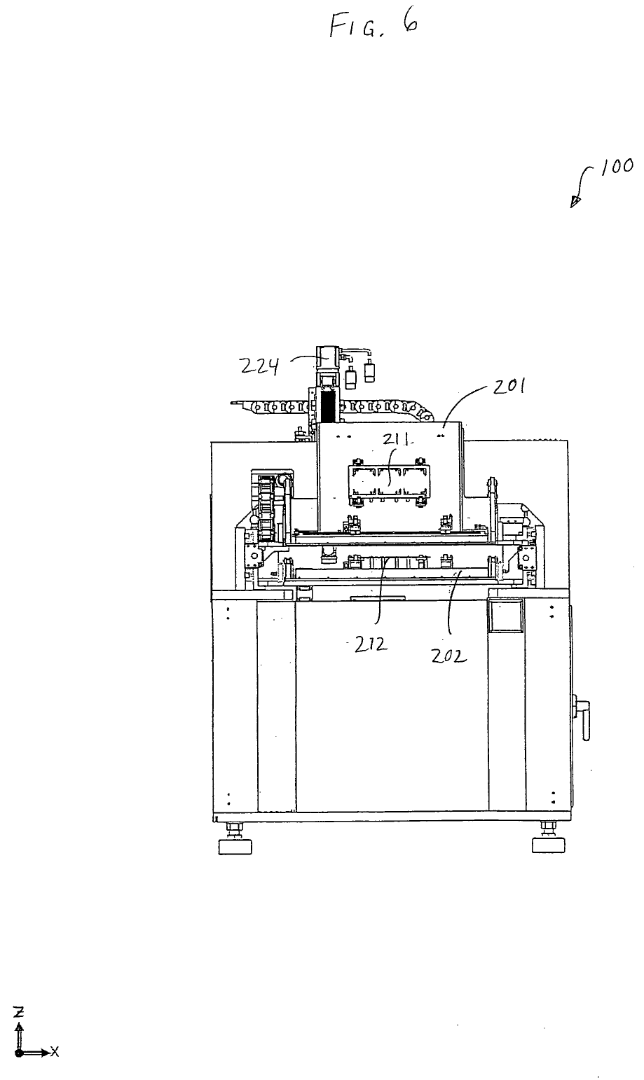

FIG. 6 is a front view of depaneling system 100 in an exemplary embodiment of the invention. FIG. 6 further illustrates how fixture pallet 201 tilts toward the operator. The operator would face depaneling system 100 and have a view similar to that of FIG. 6. With fixture pallet 201 tilted toward the operator, the operator can more easily and comfortably register panel 211 on fixture pallet 201. If fixture pallet 201 were left in a horizontal position as is illustrated for fixture pallet 202, then the operator would likely have to bend over and lean over the fixture pallet in order to register a panel on the fixture pallet. The position of fixture pallet 201 as illustrated in FIG. 6 is more ergonomically correct than the position of a horizontal fixture pallet.

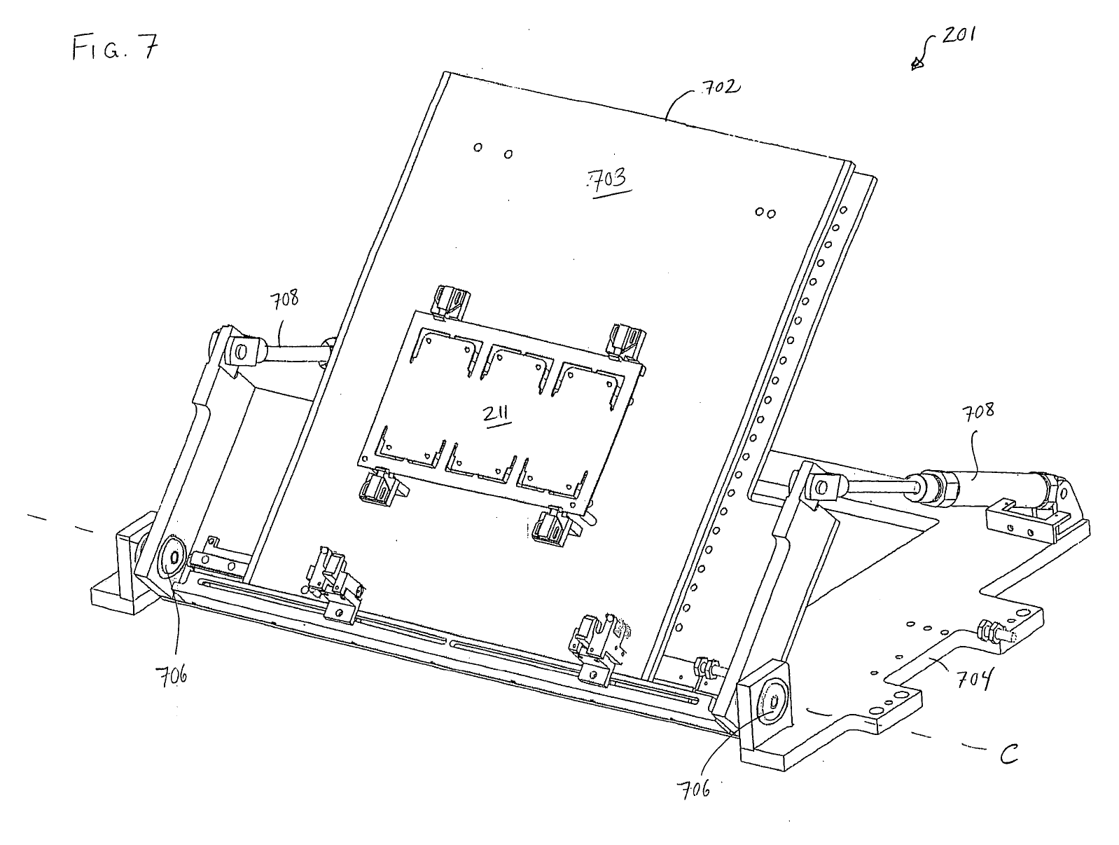

FIG. 7 is an isometric view of fixture pallet 201 in an exemplary embodiment of the invention. The structure of fixture pallet 201 shown in FIG. 7 illustrates one embodiment, and fixture pallets of the invention may be embodied having other desired structures. Fixture pallet 201 in FIG. 7 includes a registration member 702, a base 704, and a pivot mechanism 706 that connects the registration member 702 to the base 704. A registration member 702 comprises any member having a registration surface 703 adapted to register a panel of circuit boards. The registration surface 703 may have a plurality of holes adapted to receive registration pins, clamps, etc. that hold or secure a panel for cutting. Panel 211 is illustrated as being registered on clamps and registration pins. A pivot mechanism comprises any structure, device, or component upon which something turns or rotates, such as a pin, shaft, hinge, bearing, bushing, etc. Base 704 is adapted to connect fixture pallet 201 to depaneling system 100.

Fixture pallet 201 also includes an actuator mechanism 708 connected to registration member 702 and base 704. An actuator mechanism comprises any device or component for moving or controlling something, such as an air cylinder or a fluid cylinder. If actuator mechanism 708 is extended as shown in FIG. 7, then registration member 702 is tilted toward the operator. More specifically, registration member 702 pivots on a pivot axis (the C-axis) to tilt registration surface 703 toward the operator. Registration surface 703 is in a tilted position relative to the horizontal position used for cutting. Fixture pallet 201 may be tilted at any desired angle found to be ergonomically correct. References herein to tilting of a fixture pallet refer to the tilting of the registration surface of the fixture pallet.

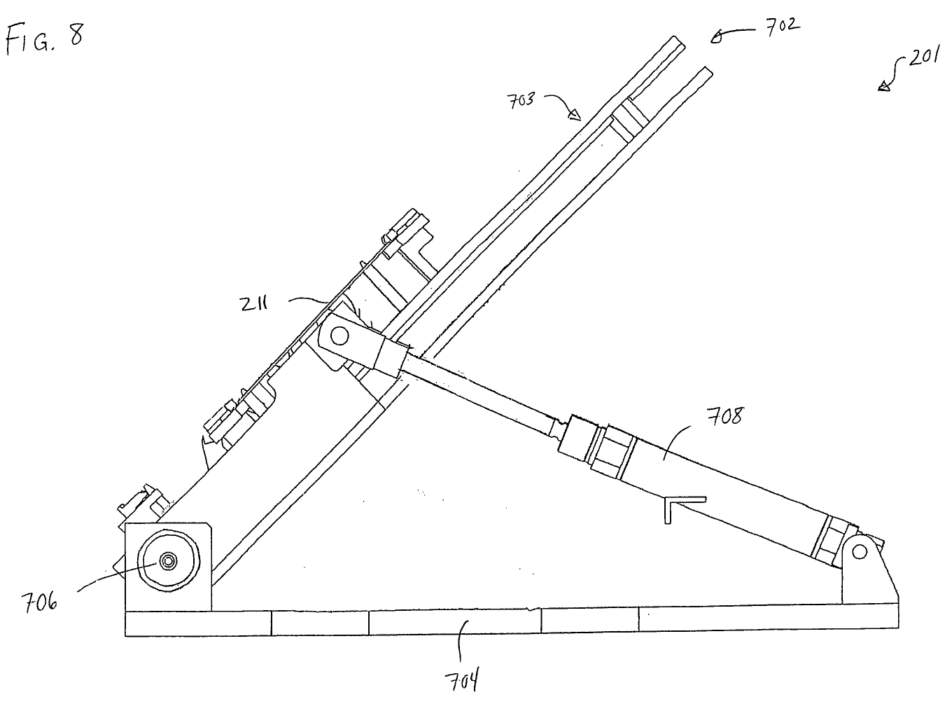

FIG. 8 is a side view of fixture pallet 201 with the registration member 702 tilted toward the operator. When the registration member 702 is tilted, registration surface 703 is at an angled position instead of in a horizontal position. This allows the operator better access to the registration surface 703 for registering panels.

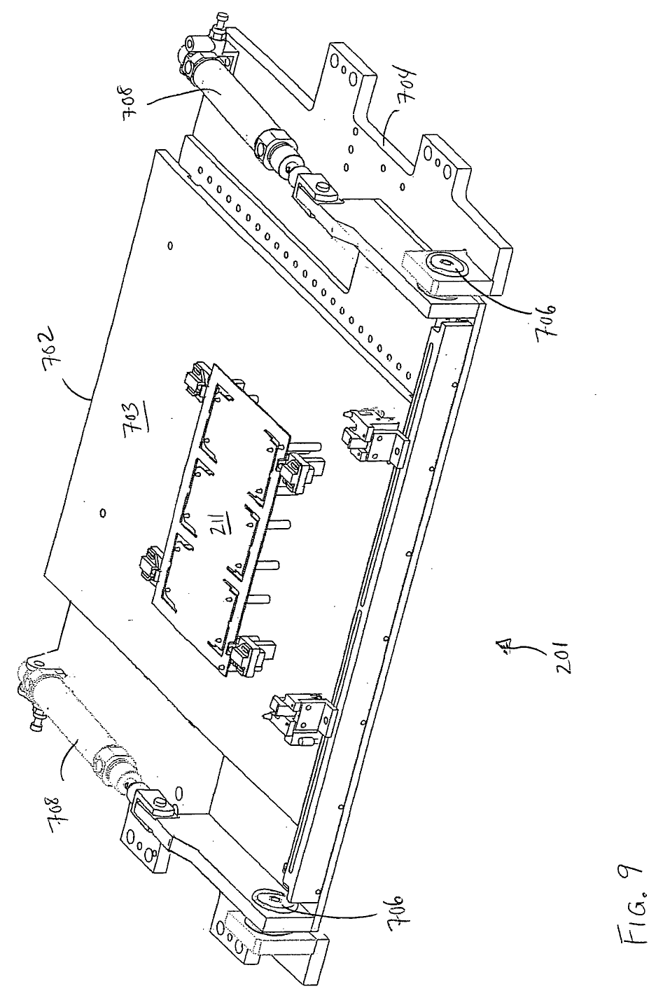

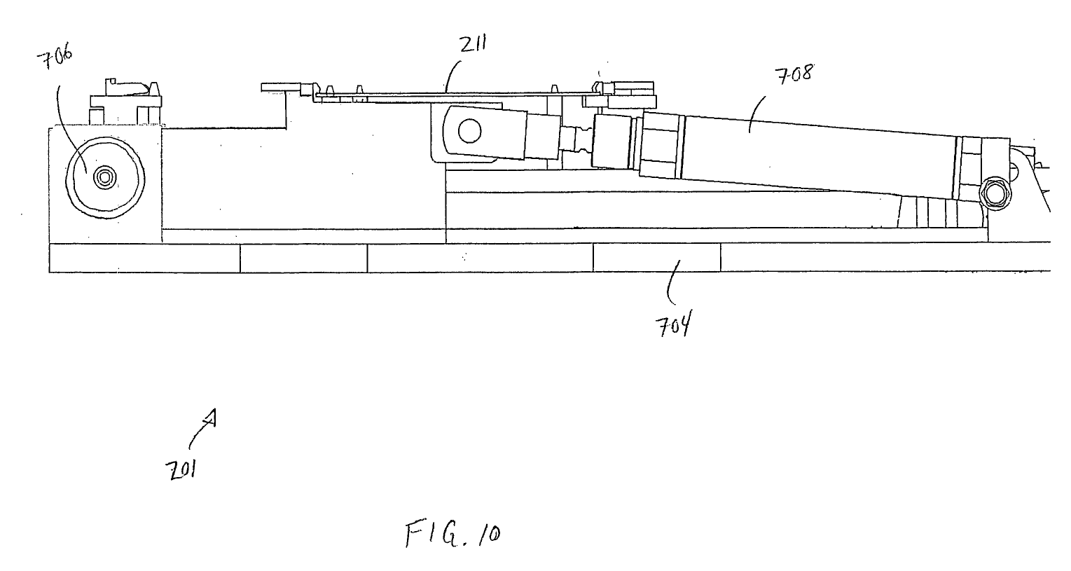

FIG. 9 is an isometric view of fixture pallet 201 with registration member 702 in a horizontal position in an exemplary embodiment of the invention. If actuator mechanism 708 is compressed as shown in FIG. 9, then registration member 702 is returned to a horizontal position. Registration surface 703 is thus horizontal relative to the ground. The horizontal position is the position generally used for cutting of the panel. FIG. 10 is a side view of fixture pallet 201 with the registration member 702 in the horizontal position.

Fixture pallet 202 may have a similar structure as fixture pallet 201. For instance, fixture pallet 202 may include a registration member, a base, and a pivot mechanism as shown for fixture pallet 201. Fixture pallet 202 may also include an actuator mechanism adapted to pivot the registration member on a pivot axis to tilt a registration surface of the registration member toward the operator as shown for fixture pallet 201.

Although specific embodiments were described herein, the scope of the invention is not limited to those specific embodiments. The scope of the invention is defined by the following claims and any equivalents thereof.

What is claimed is:

1. A depaneling system adapted to cut circuit boards from panels, the depaneling system comprising:
a first fixture pallet adapted to support a first panel of circuit boards for cutting; and
a second fixture pallet adapted to support a second panel of circuit boards for cutting;
wherein the first fixture pallet is positioned above the second fixture pallet in the depaneling system along a vertical axis.

2. The depaneling system of claim 1:
wherein a major surface of the first fixture pallet for registering the first panel defines a first plane;
wherein a major surface of the second fixture pallet for registering the second panel defines a second plane; and
wherein the positioning of the first fixture pallet relative to the second fixture pallet provides that the first plane of the first fixture pallet is situated above the second plane of the second fixture pallet along the vertical axis.

3. The depaneling system of claim 1 further comprising first rails and second rails;
wherein the first rails are positioned above the second rails relative to the ground;
wherein the first fixture pallet is moveably coupled to the first rails; and
wherein the second fixture pallet is moveably coupled to the second rails.

4. The depaneling system of claim 1 wherein:
the first fixture pallet and the second fixture pallet are each movable along a horizontal axis between a load/unload station and a cutting station of the depaneling system.

5. The depaneling system of claim 4 further comprising:
a first drive mechanism adapted to move the first fixture pallet along the horizontal axis between the load/unload station and the cutting station; and
a second drive mechanism adapted to move the second fixture pallet along the horizontal axis between the load/unload station and the cutting station.

6. The depaneling system of claim 5 further comprising:
a control system adapted to control the first drive mechanism to move the first fixture pallet to the load/unload station and to control the second drive mechanism to move the second fixture pallet to the cutting station.

7. The depaneling system of claim 6 wherein the control system is further adapted to control a cutting apparatus to cut the second panel registered on the second fixture pallet.

8. The depaneling system of claim 7 wherein the control system is further adapted to control the second drive mechanism to move the second fixture pallet from the cutting station to the load/unload station after completion of the cutting of the second panel.

9. The depaneling system of claim 8 wherein the control system is further adapted to control the first drive mechanism to move the first fixture pallet from the load/unload station to the cutting station.

10. The depaneling system of claim 9 wherein the control system is further adapted to control the cutting apparatus to cut the first panel registered on the first fixture pallet.

11. The depaneling system of claim 1 wherein:
the first fixture pallet is adapted to tilt toward an operator when the first fixture pallet is in a load/unload station; and
the second fixture pallet is adapted to tilt toward the operator when the second fixture pallet is in the load/unload station.

12. A depaneling system adapted to cut circuit boards from panels, the depaneling system comprising:
a first fixture pallet adapted to support a first panel of circuit boards for cutting, wherein a major surface of the first fixture pallet for registering the first panel defines a first plane; and
a second fixture pallet adapted to support a second panel of circuit boards for cutting, wherein a major surface of the second fixture pallet for registering the second panel defines a second plane;
wherein the positioning of the first fixture pallet relative to the second fixture pallet provides that the first plane of the first fixture pallet is situated above the second plane of the second fixture pallet along a vertical axis.

13. The depaneling system of claim 12 wherein the first plane and the second plane are substantially parallel.

14. The depaneling system of claim 13 wherein the first plane and the second plane are separated along the vertical axis by a desired spacing.

15. The depaneling system of claim 12 further comprising first rails and second rails;
wherein the first rails are positioned above the second rails relative to the ground;
wherein the first fixture pallet is moveably coupled to the first rails; and
wherein the second fixture pallet is moveably coupled to the second rails.

16. The depaneling system of claim 12 wherein:
the first fixture pallet and the second fixture pallet are each movable along a horizontal axis between a load/unload station and a cutting station of the depaneling system.

17. The depaneling system of claim 16 further comprising:
a first drive mechanism adapted to move the first fixture pallet along the horizontal axis between the load/unload station and the cutting station; and
a second drive mechanism adapted to move the second fixture pallet along the horizontal axis between the load/unload station and the cutting station.

18. The depaneling system of claim 17 further comprising:
a control system adapted to control the first drive mechanism to move the first fixture pallet between the load/unload station and the cutting station and to control the second drive mechanism to move the second fixture pallet between the load/unload station and the cutting station.

19. The depaneling system of claim 12 wherein:
the first fixture pallet is adapted to tilt toward an operator when the first fixture pallet is in a load/unload station; and
the second fixture pallet is adapted to tilt toward the operator when the second fixture pallet is in the load/unload station.

20. A depaneling system adapted to cut circuit boards from panels, the depaneling system comprising:
a frame having a first vertical member and a second vertical member;
first rails connected to the first vertical member and the second vertical member;
a first fixture pallet adapted to support a first panel of circuit boards for cutting, wherein the first fixture pallet is moveably coupled to the first rails;
second rails connected to the first vertical member and the second vertical member at a position on the first and second vertical members lower than the position of the first rails;
a second fixture pallet adapted to support a second panel of circuit boards for cutting, wherein the second fixture pallet is moveably coupled to the second rails;
wherein a major surface of the first fixture pallet for registering the first panel defines a first plane and a major surface of the second fixture pallet for registering the second panel defines a second plane;
wherein the positioning of the first fixture pallet on the first rails relative to positioning of the second fixture pallet of the second rails provides that the first plane of the first fixture pallet is situated above the second plane of the second fixture pallet along a vertical axis.
